(19) United States
(12) Patent Application Publication
(10) Pub. No.: US 2023/0238785 A1
(43) Pub. Date: Jul. 27, 2023

(54) OVERHEAD CABLE UTILIZATION SYSTEM AND OVERHEAD CABLE UTILIZATION METHOD

(71) Applicant: TOYOTA JIDOSHA KABUSHIKI KAISHA, Toyota-shi (JP)

(72) Inventors: Hiroki KAWATANA, Toyota-shi (JP); Shohei KODAMA, Toyota-shi (JP)

(73) Assignee: TOYOTA JIDOSHA KABUSHIKI KAISHA, Toyota-shi (JP)

(21) Appl. No.: 18/076,962

(22) Filed: Dec. 7, 2022

(30) Foreign Application Priority Data
Jan. 27, 2022 (JP) 2022-010962

(51) Int. Cl. H02G 1/04; H02G 7/02; H02G 7/20

(52) U.S. Cl. CPC H02G 1/04; H02G 7/02; H02G 7/20

(57) ABSTRACT

An overhead cable utilization system includes a control device configured to hold position information of the supports including heights of the supports, acquire position information of the carriage including a height of the carriage, and calculate winding-up amounts of the operating lines for the carriage to be moved to a target position. The control device is configured to calculate tilts of the operating lines suspending the carriage by using at least the position information of the supports and the position information of the carriage, and is configured to calculate the winding-up amounts of the operating lines for the carriage to be moved to the target position based on the calculated tilts of the operating lines.

### CROSS-REFERENCE TO RELATED APPLICATION

This application claims priority to Japanese Patent Application No. 2022-010962 filed on Jan. 27, 2022, incorporated herein by reference in its entirety.

### BACKGROUND

### 1. Technical Field

The present disclosure relates to techniques of using an overhead cable to move a device suspended from the overhead cable in the air.

### 2. Description of Related Art

Japanese Unexamined Patent Application Publication No. 2020-162456 (JP 2020-162456 A) discloses an overhead cable utilization system including: a plurality of supports; overhead cables supported by the supports; a hoisting device capable of winding up the overhead cables; a lifting device connected to the overhead cables and capable of moving in the air as the hoisting device winds up the overhead cables; and a detection device suspended from the lifting device. This overhead cable utilization system controls driving of the hoisting device based on detection point information while monitoring position information of the detection device. This overhead cable utilization system thus moves the detection device and the lifting device in a substantially horizontal direction and stops the hoisting device at a detection point.

### SUMMARY

In the technique described in JP 2020-162456 A, the carriage is moved based on the position information of the detection device. However, since the distance by which the carriage is moved in the horizontal direction varies depending on the tilts and deflections of the overhead cables, a position deviation may occur. Moreover, it is difficult to grasp the actual position of the carriage when the carriage is being moved on the overhead cables of the overhead cable utilization system, due to the time lag of the position information and the tilts and deflections of the overhead cables.

The present disclosure provides a technique of accurately calculating the winding-up amounts of overhead cables when controlling movement of a carriage to a target position.

An aspect of the present disclosure is an overhead cable utilization system including a first skyline and a second skyline that are supported by a plurality of supports with both ends of the first and second skylines fixed to the supports; a plurality of operating lines each movably supported by either the first skyline or the second skyline; hoisting devices configured to wind up the operating lines, and a carriage connected to the operating lines and configured to move in air between the first skyline and the second skyline; and a control device configured to hold position information of the supports including heights of the supports, acquire position information of the carriage including a height of the carriage, and calculate winding-up amounts of the operating lines for the carriage to be moved to a target position. The control device is configured to calculate tilts of the operating lines suspending the carriage by using at least the position information of the supports and the position information of the carriage, and is configured to calculate the winding-up amounts of the operating lines for the carriage to be moved to the target position based on the calculated tilts of the operating lines.

In the overhead cable utilization system of the above aspect, the control device may be configured to calculate an amount of movement of the carriage in a horizontal direction based on a difference between a current position of the carriage and the target position of the carriage. The control device may be configured to convert the calculated amount of movement in the horizontal direction to the winding-up amounts of the operating lines based on the tilts of the operating lines.

The overhead cable utilization system of the above aspect may further include: a first moving device connected to the operating lines and supported so as to be movable along the first skyline; and a second moving device connected to the operating lines and supported so as to be movable along the second skyline. The carriage may be movable in the air between the first moving device and the second moving device. The control device may be configured to acquire position information of the first moving device and the second moving device including heights of the first moving device and the second moving device. The control device may be configured to calculate tilts of the operating lines connected to the first moving device and the second moving device, based on the position information of the supports and the position information of the first moving device and the second moving device. The control device may be configured to calculate winding-up amounts of the operating lines according to amounts of movement of the first moving device and the second moving device in the horizontal direction, based on the calculated tilts of the operating lines.

Another aspect of the present disclosure is an overhead cable utilization method that is performed by a computer using an overhead cable utilization system, the overhead cable utilization system including a first skyline and a second skyline that are supported by a plurality of supports with both ends of the first and second skylines fixed to the supports, a plurality of operating lines each movably supported by either the first skyline or the second skyline, a hoisting device configured to wind up the operating lines, and a carriage connected to the operating lines and configured to move in air between the first skyline and the second skyline. The method includes the steps of: holding position information of the supports including heights of the supports; acquiring position information of the carriage including a height of the carriage; and calculating winding-up amounts of the operating lines for the carriage to be moved to a target position. The calculating step includes calculating tilts of the operating lines suspending the carriage by using at least the position information of the supports and the position information of the carriage, and calculating the winding-up amounts of the operating lines for the carriage to be moved to the target position based on the calculated tilts of the operating lines.

The present disclosure can provide a technique of accurately calculating the winding-up amounts of overhead cables when controlling movement of a carriage to a target position.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 illustrates an overhead cable utilization system;

FIG. 2 shows functional configurations of the overhead cable utilization system according to an embodiment;

FIG. 3 is a top view of the overhead cable utilization system, illustrating movement of a carriage in the Y direction;

FIG. 4 shows the overhead cable utilization system as viewed in the X direction, illustrating a method for calculating a winding-up amount for the amount of movement of a first moving device in the horizontal direction;

FIG. 5 shows the overhead cable utilization system as viewed in the Y direction, illustrating movement of the carriage in the X and Z directions; and

FIG. 6 is a flowchart of a process of moving the carriage to a target position.

### DETAILED DESCRIPTION OF EMBODIMENTS

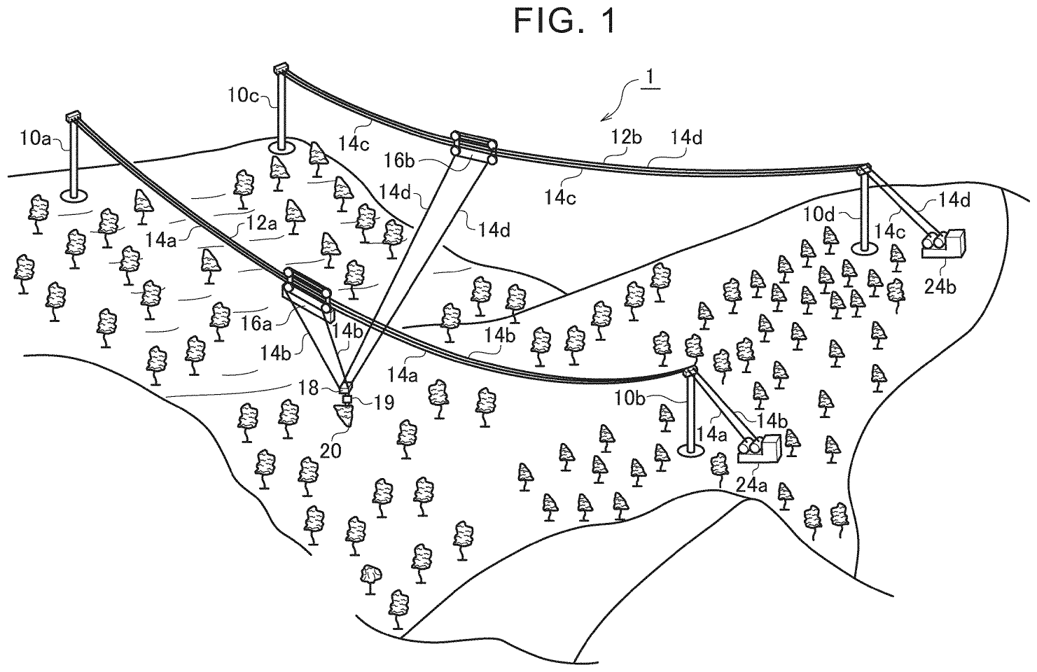

FIG. 1 illustrates an overhead cable utilization system 1. The overhead cable utilization system 1 includes: a first support 10a, a second support 10b, a third support 10c, and a fourth support 10d; a first skyline 12a and a second skyline 12b; a first operating line 14a, a second operating line 14b, a third operating line 14c, and a fourth operating line 14d; a first moving device 16a and a second moving device 16b; a carriage 18; a gripping device 19; a control device (not shown); and a first hoisting device 24a and a second hoisting device 24b.

The overhead cable utilization system 1 is a so-called H-type overhead cable utilization system, and can lift a tree 20 felled in a forest by the skylines 12a, 12b and the operating lines 14a, 14b, 14c, 14d (these skylines and operating lines are called “overhead cables”) that are suspended in the air, and transport the tree 20 to near a collection site. The tree 20 can thus be transported from the forest without building a road.

The four supports 10a, 10b, 10c, 10d are installed to stand at positions suitable for installation that are determined based on the distribution of standing trees and the position of the collection site. The supports 10a, 10b, 10c, 10d have a size of about 5 meters to about 10 meters depending on the size of the overhead cable utilization system 1 etc.

The skylines 12a, 12b and the operating lines 14a, 14b, 14c, 14d are fixed to the supports 10a, 10b, 10c, 10d as overhead cables, or are led through blocks on the supports 10a, 10b, 10c, 10d. The first skyline 12a is fixed to the first support 10a and the second support 10b, and the second skyline 12b is fixed to the third support 10c and the fourth support 10d. The first and second skylines 12a, 12b thus function as rails in the air.

The skylines 12a, 12b may be fixed to the ground near the supports 10a, 10b, 10c, 10d via the supports 10a, 10b, 10c, 10d. The first skyline 12a and the second skyline 12b are installed so as not to cross each other. The length of the skylines 12a, 12b is about 300 meters to about 2000 meters.

The operating lines 14a, 14b, 14c, 14d function as moving lines that are wound up by the hoisting devices 24a, 24b, and move the moving devices 16a, 16b and the carriage 18. The first operating line 14a and the third operating line 14c are used to move the moving devices 16a, 16b, and the second operating line 14b and the fourth operating line 14d are used to move the carriage 18 between the skylines 12a, 12b.

The first operating line 14a and the third operating line 14c are led through blocks on the supports 10a, 10b, 10c, 10d. Each of the first and third operating lines 14a, 14c has its one end connected to a corresponding one of the moving devices 16a, 16b, and has the other end connected to a corresponding one of the hoisting devices 24a, 24b. The first operating line 14a includes an operating line connected from the first hoisting device 24a to the first moving device 16a via the second support 10b, the first moving device 16a, and the first support 10a, and an operating line connected from the first hoisting device 24a to the first moving device 16a via the second support 10b. The first operating line 14a is provided in order to move the first moving device 16a. That is, one of the operating lines of the first operating line 14a is passed through the second support 10b and the first moving device 16a, is turned back at the first support 10a, and is connected to the first moving device 16a.

The third operating line 14c includes an operating line connected from the second hoisting device 24b to the second moving device 16b via the fourth support 10d, the second moving device 16b, and the third support 10c, and an operating line connected from the second hoisting device 24b to the second moving device 16b via the fourth support 10d.

The third operating line 14c is provided in order to move the second moving device 16b. That is, one of the operating lines of the third operating line 14c is passed through the fourth support 10d and the second moving device 16b, is turned back at the third support 10c, and is connected to the second moving device 16b.

The second operating line 14b has its one end fixed to the first hoisting device 24a and the other end fixed to the first support 10a. The second operating line 14b is fixed from the first hoisting device 24a to the first support 10a via the second support 10b, the first moving device 16a, the carriage 18, and the first moving device 16a. That is, the second operating line 14b extends from the first hoisting device 24a to the second support 10b, extends from the second support 10b to the first moving device 16a, is bent at the first moving device 16a, is turned back at the carriage 18 toward the first moving device 16a, is bent again at the first moving device 16a, and is connected to the first support 10a.

The fourth operating line 14d has its one end fixed to the second hoisting device 24b and the other end fixed to the third support 10c. The fourth operating line 14d is fixed from the second hoisting device 24b to the third support 10c via the fourth support 10d, the second moving device 16b, the carriage 18, and the second moving device 16b. That is, the fourth operating line 14d extends from the second hoisting device 24b to the fourth support 10d, extends from the fourth support 10d to the second moving device 16b, is bent at the second moving device 16b, is turned back at the carriage 18 toward the second moving device 16b, is bent again at the second moving device 16b, and is connected to the third support 10c.

Each of the pair of moving devices 16a, 16b is supported by a corresponding one of the pair of skylines 12a, 12b and is movable along this skyline 12a, 12b. The carriage 18 suspends the gripping device 19 via a lifting wire. The supports 10a, 10b, 10c, 10d, the moving devices 16a, 16b, and the carriage 18 are provided with a position detection unit that detects position information of the carriage 18 using a satellite positioning system. The gripping device 19 is capable of gripping the tree 20 The carriage 18 is provided with a drive source for lifting and lowering the gripping device 19.

Each of the hoisting devices 24a, 24b functions as winches for winding up corresponding one of the operating lines 14a, 14b, 14c, 14d, and includes drums for winding up or unwinding the operating lines 14a, 14b, 14c, 14d and a motor. Each hoisting device 24a, 24b drives the motor to rotate the drums according to a drive instruction from the control device, and transmits the driving result to the control device.

The operation of the overhead cable utilization system 1 will be described.

The first hoisting device 24a moves the first moving device 16a along the first skyline 12a by winding up the one operating line of the first operating line 14a and unwinding the other operating line of the first operating line 14a. The second hoisting device 24b moves the second moving device 16b along the second skyline 12b by winding up the one operating line of the third operating line 14c and unwinding the other operating line of the third operating line 14c. The carriage 18 is thus displaced in the direction along the skylines 12a, 12b. A direction parallel to the first skyline 12a is sometimes referred to as the “Y direction,” a direction in which the first skyline 12a and the second skyline 12b face each other and that is perpendicular to the Y direction is sometimes referred to as the “X direction,” and the vertical direction is sometimes referred to as the “Z direction.”

Next, movement of the carriage 18 in the direction in which the first skyline 12a and the second skyline 12b face each other will be described. When the hoisting devices 24a, 24b wind up one of the second and fourth operating lines 14b, 14d and unwind the other operating line, the distance from the first moving device 16a to the carriage 18 and the distance from the second moving device 16b to the carriage 18 change, and the carriage 18 is displaced in the X direction between the first moving device 16a and the second moving device 16b.

The carriage 18 is lifted when the hoisting devices 24a, 24b wind up both of the second and fourth operating lines 14b, 14d. The carriage 18 is lowered when the hoisting devices 24a, 24b unwind both of the second and fourth operating lines 14b, 14d. The carriage 18 is thus displaced in the Z direction. By combining winding up and unwinding of the operating lines 14a, 14b, 14c, 14d in this manner, the carriage 18 can be moved in the three axial directions within the area surrounded by the four supports 10a, 10b, 10c, 10d.

In the form of the overhead cable utilization system 1 shown in FIG. 1, one set of hoisting devices, namely the first hoisting device 24a and the second hoisting device 24b, wind up the operating lines 14a, 14b, 14c, 14d. However, the present disclosure is not limited to this form. For example, four hoisting devices that wind up the operating lines 14a, 14b, 14c, 14d may be installed for each support 10a, 10b, 10c, 10d. In this case, the operating lines 14a, 14b, 14c, 14d need not be turned back to extend to the hoisting devices 24a, 24b. Therefore, the overall length of the operating lines 14a, 14b, 14c, 14d can be reduced, and the load applied to the supports 10a, 10b, 10c, 10d can be reduced. The arrangement of the overhead cables is not limited to this form, and common operating lines 14a, 14b, 14c, 14d may be used. The number of operating lines 14a, 14b, 14c, 14d is not limited to six, and may be four.

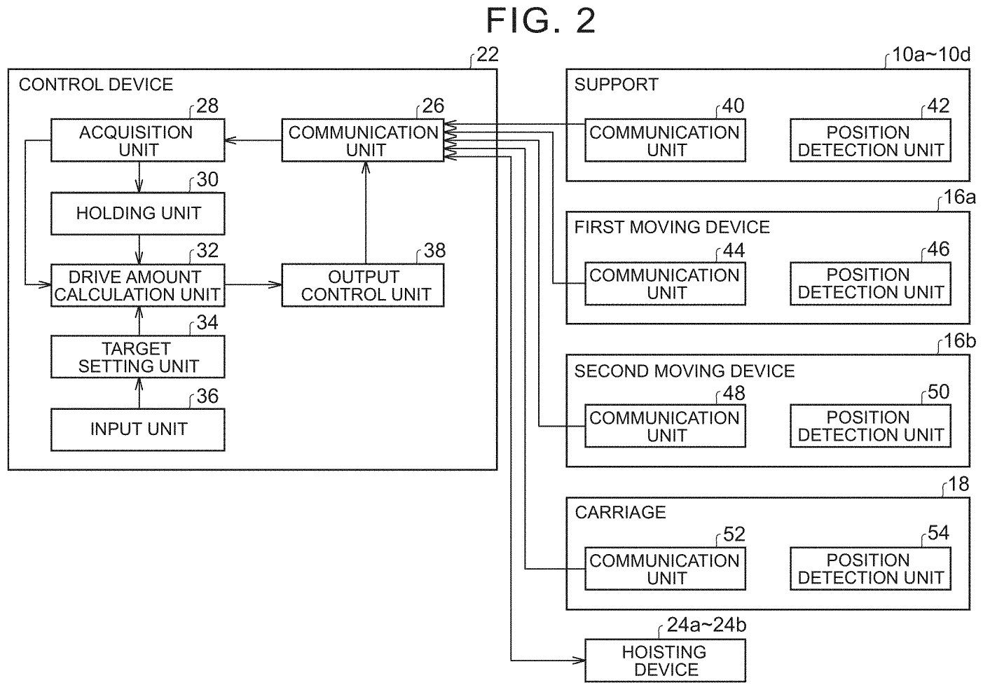

FIG. 2 shows functional configurations of the overhead cable utilization system 1 according to the present embodiment. Functions of the overhead cable utilization system 1 can be implemented by circuit blocks, memories, and other large-scale integration (LSI) in terms of hardware, and are implemented by system software, application programs, etc. loaded in a memory in terms of software. Accordingly, it should be understood by those skilled in the art that each function of the overhead cable utilization system 1 can be implemented in various forms by hardware alone, software alone, or a combination thereof, and is not limited to any of these.

Each of the supports 10a, 10b, 10c, 10d includes a communication unit 40 and a position detection unit 42 that detects position information of the support 10a, 10b, 10c, 10d using a global navigation satellite system (GNSS). The position detection unit 42 is mounted at the top of the support 10a, 10b, 10c, 10d and detects the height of the support 10a, 10b, 10c, 10d. That is, the position information detected by the position detection unit 42 includes position information on a horizontal plane specified by latitude and longitude and position information in the height direction. The position information in the height direction may be an elevation. The position detection unit 42 may have a Global Positioning System (GPS) device and an altitude sensor. The top of the support 10a, 10b, 10c, 10d is the position where the support 10a, 10b, 10c, 10d and the operating lines 14a, 14b, 14c, 14d are engaged. The position information of the support 10a, 10b, 10c, 10d need only be transmitted to a control device 22 once.

The first moving device 16a includes a communication unit 44 and a position detection unit 46 that detects position information of the first moving device 16a using the global navigation satellite system. The position detection unit 46 detects not only the position of the first moving device 16a on a horizontal plane but also the height of the first moving device 16a. The position detection unit 46 detects position information, for example, 10 times per second, and the communication unit 44 periodically transmits the position information to the control device 22.

The second moving device 16b includes a communication unit 48 and a position detection unit 50 that detects position information of the second moving device 16b using the global navigation satellite system. The position detection unit 50 detects the position of the second moving device 16b on a horizontal plane and the height of the second moving device 16b.

The carriage 18 includes a communication unit 52 and a position detection unit 54 that detects position information of the carriage 18 using the global navigation satellite system. The position detection unit 54 detects the position of the carriage 18 on a horizontal plane and the height of the carriage 18. As described above, the supports 10a, 10b, 10c, 10d, the moving devices 16a, 16b, and the carriage 18 transmit their position information to the control device 22.

The control device 22 includes a communication unit 26, an acquisition unit 28, a holding unit 30, a drive amount calculation unit 32, a target setting unit 34, an input unit 36, and an output control unit 38.

The control device 22 allows remote control of the hoisting devices 24a, 24b, the carriage 18, and the gripping device 19, and is installed in a control room. The communication unit 26 can wirelessly communicate with the moving devices 16a, 16b, the hoisting devices 24a, 24b, the carriage 18, and the gripping device 19.

The control device 22 includes the input unit 36 including a touch panel that receives operations performed by an operator and a mechanical controller. Control for moving the carriage 18 is performed by a program installed in advance. Control for lowering the gripping device 19 and control for gripping the tree 20 may be performed by programs installed in advance, or may be performed by operations performed by the operator via the control device 22. For example, the operator performs control while looking at images transmitted from cameras installed on the carriage 18, the gripping device 19, etc. As described above, the control of the overhead cable utilization system 1 may be a combination of programs and operations performed by the operator.

The acquisition unit 28 acquires the position information of the supports 10a, 10b, 10c, 10d, the moving devices 16a, 16b, and the carriage 18 via the communication unit 26, and causes the holding unit 30 to hold the acquired position information. The operator may measure the position information of the supports 10a, 10b, 10c, 10d in advance and cause the holding unit 30 to hold the measured position information.

The input unit 36 receives input from the operator. The operator enters a target position of the carriage 18, and the input unit 36 acquires information on the entered target position. The target position information may be transmitted from another server device. The target position information is, for example, the position coordinates of the tree 20 to be felled or the position coordinates of the collection site. The target setting unit 34 sets the target position of the carriage 18. The target position information includes latitude, longitude, and height.

The drive amount calculation unit 32 calculates the winding-up amounts of the hoisting devices 24a, 24b for the carriage 18 to be moved to the target position. The drive amount calculation unit 32 also calculates the rotational speed of each hoisting device 24a, 24b. The rotational speed of each hoisting device 24a, 24b is calculated so that the rotational speed is lower in a start section and a stop section than in a section therebetween. The rotational speed of each hoisting device 24a, 24b may be calculated so that the rotational speed is higher when the carriage 18 does not carry any object than when the carriage 18 carries an object. The drive amount calculation unit 32 generates a drive instruction to gradually reduce the rotational speed of the motor of each hoisting device 24a, 24b to stop the carriage 18. For the stop control, the deceleration for reducing the rotational speed of the motor is set in advance, and is set by experiments etc. so that the tree suspended from the carriage 18 does not swing greatly. The drive amount calculation unit 32 generates drive instruction information according to the rotational speed and winding-up amount of each hoisting device 24a, 24b, and the output control unit 38 controls the output of each hoisting device 24a, 24b based on the drive instruction information.

The operating lines 14a, 14b, 14c, 14d suspending the carriage 18 are so long that they are tilted with respect to the horizontal direction. Accordingly, the winding-up amounts of the operating lines 14a, 14b, 14c, 14d by the hoisting devices 24a, 24b and the distance by which the carriage 18 is moved in the horizontal direction do not match. The drive amount calculation unit 32 therefore calculates the winding-up amounts of the operating lines 14a, 14b, 14c, 14d in consideration of the tilts of the operating lines 14a, 14b, 14c, 14d as well. When the winding-up amount is a negative value, it means that the operating line is unwound. When the term “winding-up amount” is used, it also includes the case where the operating line is unwound.

The drive amount calculation unit 32 calculates the tilts of the operating lines 14a, 14b, 14c, 14d suspending the carriage 18 by using at least the position information of the supports 10a, 10b, 10c, 10d and the position information of the carriage 18, and calculates the winding-up amounts of the operating lines 14a, 14b, 14c, 14d for the carriage 18 to be moved to the target position based on the calculated tilts of the operating lines 14a, 14b, 14c, 14d.

The drive amount calculation unit 32 calculates the tilts of the operating lines 14a, 14b, 14c, 14d connected to the first moving device 16a and the second moving device 16b, based on the position information of the supports 10a, 10b, 10c, 10d and the position information of the first and second moving devices 16a, 16b. The drive amount calculation unit 32 also calculates the winding-up amounts of the operating lines 14a, 14b, 14c, 14d according to the amounts of movement of the first and second moving devices 16a, 16b in the horizontal direction, based on the calculated tilts of the operating lines 14a, 14b, 14c, 14d. A method for calculating the winding-up amount will be described in detail with reference to new drawings.

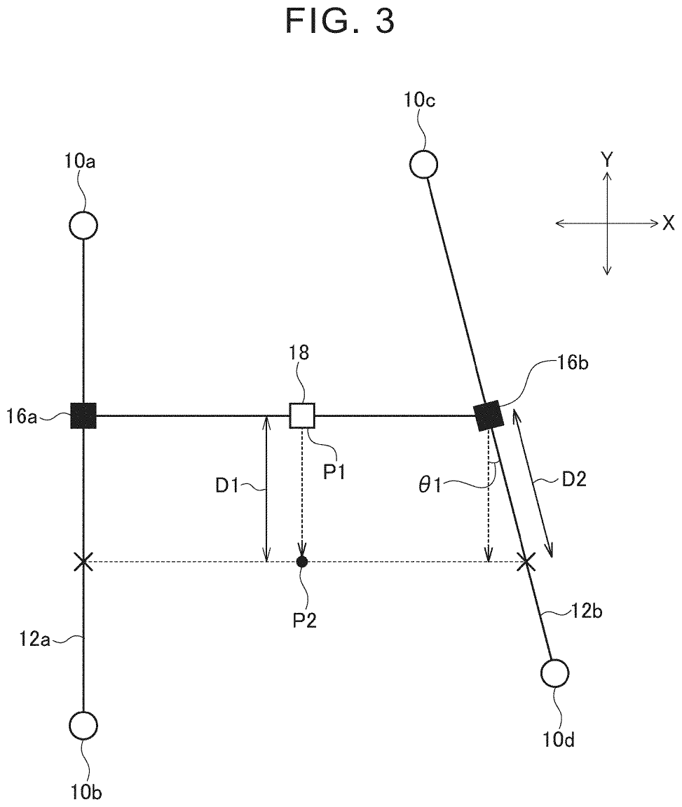

FIG. 3 is a top view of the overhead cable utilization system 1, illustrating movement of the carriage 18 in the Y direction. The carriage 18 is to be moved from a current position P1 to a target position P2 in the Y direction. The first moving device 16a and the second moving device 16b are located side by side in the X direction.

The drive amount calculation unit 32 acquires the target position P2 and calculates the amounts of movement of the first moving device 16a and the second moving device 16b in the horizontal direction. The amount of movement of the first moving device 16a in the horizontal direction is calculated to be the amount of movement D1 in the Y direction, based on the current position P1 and the target position P2 of the carriage 18. In the actual calculation process, the amount of movement in the horizontal direction is calculated based on the position coordinates specified by latitude and longitude.

The amount of movement of the second moving device 16b in the horizontal direction is calculated to be the amount of movement D2, based on the amount of movement D1 in the Y direction and the tilt θ1 of the second skyline 12b (third operating line 14c) with respect to the first skyline 12a (first operating line 14a). The tilt 01 of the second skyline 12b with respect to the first skyline 12a is calculated based on the line segment calculated from the position information of the first and second supports 10a, 10b and the line segment calculated from the position information of the third and fourth supports 10c, 10d. The amount of movement of the carriage 18 to the target position P2 in the Y direction is resolved into the amount of movement of the first moving device 16a and the amount of movement of the second moving device 16b. The amount of movement D1 of the first moving device 16a in the Y direction and the amount of movement D2 of the second moving device 16b do not reflect the tilt of the first skyline 12a. The first skyline 12a and the first operating line 14a have the same tilt, and the second skyline 12b and the third operating line 14c have the same tilt.

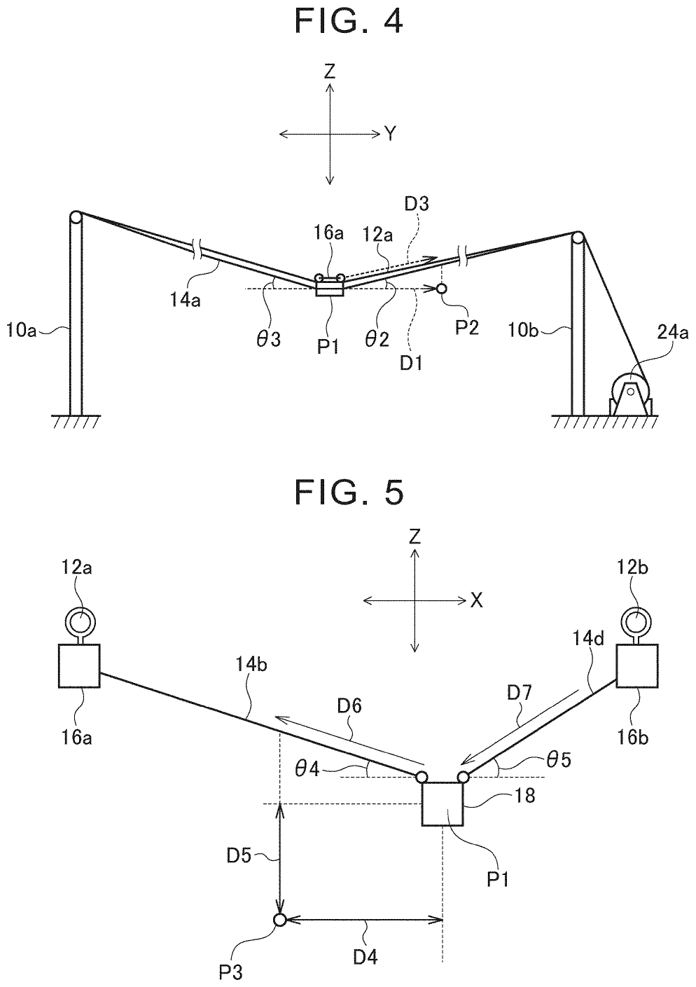

FIG. 4 shows the overhead cable utilization system 1 as viewed in the X direction, illustrating a method for calculating the winding-up amount D3 for the amount of movement D1 of the first moving device 16a in the horizontal direction. The amount of movement of the first moving device 16a that is necessary to move the carriage 18 from the current position P1 to the target position P2 is the amount of movement D1 in the horizontal direction.

The drive amount calculation unit 32 calculates the tilt θ2 of the first operating line 14a based on the position information of the first moving device 16a and the position information of the second support 10b, and calculates the winding-up amount D3 of the first hoisting device 24a based on the calculated tilt θ2 of the first operating line 14a and the amount of movement D1 in the horizontal direction. The winding-up amount D3 is thus calculated by converting the amount of movement D1 of the first moving device 16a based on the tilt θ2 of the first operating line 14a. In the case where the first moving device 16a is moved toward the first support 10a, the amount of movement D1 is converted based on the tilt 03 of the first operating line 14a. The tilt 03 of the first operating line 14a is calculated based on the position information of the first support 10a and the position information of the first moving device 16a. The amount of movement D2 of the second moving device 16b is similarly converted to the winding-up amount based on the tilt of the third operating line 14c.

The first moving device 16a is moved to the target position P2 as the first hoisting device 24a winds up the first operating line 14a by the winding-up amount D3.

FIG. 5 shows the overhead cable utilization system 1 as viewed the Y direction, illustrating movement of the carriage 18 in the X and Z directions. FIG. 5 shows a process of moving the carriage 18 from the position P1 to a target position P3.

The drive amount calculation unit 32 calculates the amount of movement D4 of the carriage 18 in the X-direction and the amount of movement D5 of the carriage 18 in the Z direction, based on the position P1 and the target position P3 of the carriage 18. The drive amount calculation unit 32 calculates the winding-up amount D6 of the second operating line 14b based on the amount of movement D4 in the X direction and the tilt 04 of the second operating line 14b. The tilt θ4 of the second operating line 14b is calculated based on the position information of the first moving device 16a and the position information of the carriage 18. The winding-up amount D6 is thus calculated by converting the amount of movement D4 in the X direction based on the tilt θ4 of the second operating line 14b.

The drive amount calculation unit 32 calculates the winding-up amount D7 of the fourth operating line 14d, based on the amount of movement D4 in the X direction and the tilt θ5 of the fourth operating line 14d. The winding-up amount D7 is a negative value, and the second hoisting device 24b unwinds the fourth operating line 14d. The winding-up amount D6 of the second operating line 14b and the winding-up amount D7 of the fourth operating line 14d are thus calculated based on the amount of movement D4 in the X direction, the tilt θ4 of the second operating line 14b, and the tilt θ5 of the fourth operating line 14d. The carriage 18 is moved by the amount of movement D4 in the X direction as the first hoisting device 24a winds up the second operating line 14b by the winding-up amount D6 and the second hoisting device 24b unwinds the fourth operating line 14d by the winding-up amount D7.

Thereafter, the drive amount calculation unit 32 inputs the amount of movement D5 and the tilt θ4 of the second operating line 14b into a predetermined function to calculate the winding-up amount of the second operating line 14b that is necessary to lower the carriage 18 by the amount of movement D5. The drive amount calculation unit 32 also inputs the amount of movement D5 and the tilt θ5 of the fourth operating line 14d into a predetermined function to calculate the winding-up amount of the fourth operating line 14d that is necessary to lower the carriage 18 by the amount of movement D5. The winding-up amounts of the second and fourth operating lines 14b, 14d are calculated to be smaller than the amount of movement D5 in the Z direction.

As described above, the drive amount calculation unit 32 resolves the difference between the current position and the target position of the carriage 18 into components in the X, Y, and Z directions, and converts the amount of movement of each of these components into the winding-up amounts of the operating lines 14a, 14b, 14c, 14d based on the tilts of the operating lines 14a, 14b, 14c, 14d. For movement in the Y direction, the hoisting devices 24a, 24b wind up the first operating line 14a and the third operating line 14c according to the calculated winding-up amounts. For movement in the X and Z directions, the hoisting devices 24a, 24b wind up the second operating line 14b and the fourth operating line 14d according to the calculated winding-up amounts. The tilts of the operating lines 14a, 14b, 14c, 14d can thus be reflected when moving the carriage 18 to the target position. As a result, the carriage 18 can be accurately moved to the target position. The position of the carriage 18 may be finally adjusted toward the target position by feedback control.

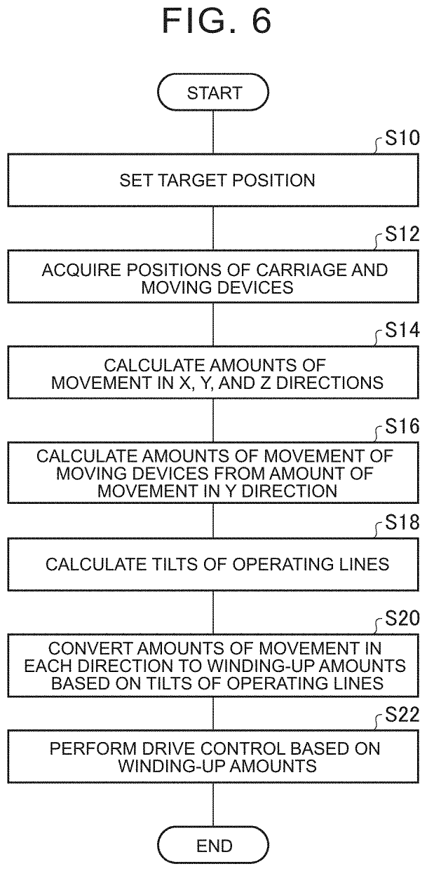

FIG. 6 is a flowchart of a process of moving the carriage 18 to the target position. The target setting unit 34 receives the target position information from the input unit 36 and sets the target position (S10). The acquisition unit 28 acquires the position information of the moving devices 16a, 16b and the carriage 18 (S12).

The drive amount calculation unit 32 resolves the distance from the position of the carriage 18 to the target position into compositions in the X, Y, and Z directions, and calculates the amounts of movement in these three directions (S14). The drive amount calculation unit 32 calculates the amounts of movement of the first moving device 16a and the second moving device 16b from the amount of movement in the Y direction (S16).

The drive amount calculation unit 32 calculates the tilts of the operating lines 14a, 14b, 14c, 14d as shown in FIGS. 4 and 5 (S18). The drive amount calculation unit 32 converts the amounts of movement in the three directions to the winding-up amounts of the operating lines 14a, 14b, 14c, 14d, based on the tilts of the operating lines 14a, 14b, 14c, 14d (S20). In this conversion process, the amounts of movement and the tilts of the operating lines 14a, 14b, 14c, 14d may be input to a predetermined function to calculate the winding-up amount, or a two-dimensional map may be used to calculate the winding-up amounts corresponding to the amounts of movement and the tilts of the operating lines 14a, 14b, 14c, 14d.

The drive amount calculation unit 32 generates instruction information based on the calculated winding-up amounts of the operating lines 14a, 14b, 14c, 14d, and the output control unit 38 controls the hoisting devices 24a, 24b according to the winding-up amounts of the operating lines 14a, 14b, 14c, 14d (S22).

The present disclosure is described above based on the embodiment. It should be understood by those skilled in the art that the embodiment is presented by way of example only, that various modifications can be made to the combination of components and processes, and that such modifications fall within the scope of the present disclosure.

The above embodiment illustrates the form in which the gripping device 19 grips a tree. However, the present disclosure is not limited to this form. For example, an inspection device that detects the state of a tree may be suspended from the carriage 18. A cutting device that cuts a tree may be suspended from the carriage 18. As described above, an operating device suspended from the carriage 18 is not limited to the gripping device 19, but is a device that performs a predetermined operation, and can be replaced according to the application.

The above embodiment illustrates the form in which the overhead cable utilization system 1 is installed in a forest to transport a tree 20. However, the present disclosure is not limited to this form. For example, the overhead cable utilization system 1 may be installed in a fish farm for fishery to transport feed and caught fishery products. The overhead cable utilization system 1 may be installed in a mine or a mining site to transport equipment and minerals. The overhead cable utilization system 1 may be installed in a construction site to transport building materials. As described above, the form in which the overhead cable utilization system 1 is used is not limited to forestry, but can be used in the businesses of transporting objects.

The above embodiment illustrates the form in which the carriage 18 is moved in the three axial directions by the control device 22. However, the present disclosure is not limited to this form. For example, the control device 22 may perform movement control only in the X and Y directions. In this form, a vertically movable device is suspended from the carriage 18.

The above embodiment illustrates the form in which the carriage 18 is located between the pair of moving devices 16a, 16b. However, the present disclosure is not limited to this form. For example, the carriage 18 may be connected to four operating lines 14a, 14b, 14c, 14d extending from the four supports 10a, 10b, 10c, 10d and supported by the operating lines 14a, 14b, 14c, 14d arranged in a so-called X-shape.

What is claimed is:

1. An overhead cable utilization system comprising:
a first skyline and a second skyline that are supported by a plurality of supports with both ends of the first skyline and the second skyline fixed to the supports;
a plurality of operating lines each movably supported by either the first skyline or the second skyline;
hoisting devices configured to wind up the operating lines;
a carriage connected to the operating lines and configured to move in air between the first skyline and the second skyline; and
a control device configured to
hold position information of the supports including heights of the supports,
acquire position information of the carriage including a height of the carriage, and
calculate winding-up amounts of the operating lines for the carriage to be moved to a target position, wherein
the control device is configured to
calculate tilts of the operating lines suspending the carriage by using at least the position information of the supports and the position information of the carriage, and
calculate the winding-up amounts of the operating lines for the carriage to be moved to the target position based on the calculated tilts of the operating lines.

2. The overhead cable utilization system according to claim 1, wherein the control device is configured to
calculate an amount of movement of the carriage in a horizontal direction based on a difference between a current position of the carriage and the target position of the carriage, and
convert the calculated amount of movement in the horizontal direction to the winding-up amounts of the operating lines based on the tilts of the operating lines.

3. The overhead cable utilization system according to claim 1, further comprising:
a first moving device connected to the operating lines and supported so as to be movable along the first skyline; and
a second moving device connected to the operating lines and supported so as to be movable along the second skyline, wherein:
the carriage is movable in the air between the first moving device and the second moving device; and
the control device is configured to
acquire position information of the first moving device and the second moving device including heights of the first moving device and the second moving device,
calculate tilts of the operating lines connected to the first moving device and the second moving device, based on the position information of the supports and the position information of the first moving device and the second moving device, and
calculate winding-up amounts of the operating lines according to amounts of movement of the first moving device and the second moving device in a horizontal direction, based on the calculated tilts of the operating lines.

4. An overhead cable utilization method that is performed by a computer using an overhead cable utilization system, the overhead cable utilization system including a first skyline and a second skyline that are supported by a plurality of supports with both ends of the first skyline and the second skyline fixed to the supports, a plurality of operating lines each movably supported by either the first skyline or the second skyline, hoisting devices configured to wind up the operating lines, and a carriage connected to the operating lines and configured to move in air between the first skyline and the second skyline, the method comprising:
a holding step of holding position information of the supports including heights of the supports;
an acquiring step of acquiring position information of the carriage including a height of the carriage; and
a calculating step of calculating winding-up amounts of the operating lines for the carriage to be moved to a target position, wherein
the calculating step includes calculating tilts of the operating lines suspending the carriage by using at least the position information of the supports and the position information of the carriage, and calculating the winding-up amounts of the operating lines for the carriage to be moved to the target position based on the calculated tilts of the operating lines.
